(19) United States
(12) Patent Application Publication
(10) Pub. No.: US 2025/0166271 A1
(43) Pub. Date: May 22, 2025

(54) APPARATUS AND METHOD FOR PROVIDING SPEECH VIDEO

(71) Applicant: DEEPBRAIN AI INC., Seoul (KR)

(72) Inventor: DOO HYUN KIM, Gyeonggi-do (KR)

(21) Appl. No.: 18/839,543

(22) PCT Filed: Aug. 23, 2022
(86) PCT No.: PCT/KR2022/095117

§ 371 Date: Aug. 19, 2024

(30) Foreign Application Priority Data
Aug. 16, 2022 (KR) 10-2022-0102315

(51) Int. Cl. G06T 13/00

(52) U.S. Cl. CPC G06T 13/00; G06T 2210/32

(57) ABSTRACT

In a method for providing a speech video performed by a computing device, a standby state video in a video file format in which a person in the video is in a standby state is reproduced, a plurality of speech state images in which the person in the video is in a speech state and a speech voice based on a source of speech contents during the reproduction of the standby state video are generated, the reproduction of the standby state video is stopped and a back motion video in a video file format for returning to a reference frame of the standby state video is reproduced, and a synthesized speech video is generated by synthesizing the plurality of speech state images and the speech voice with the standby state video from the reference frame.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2022/095117, filed Aug. 23, 2022, which claims priority to the benefit of Korean Patent Application No. 10-2022-0102315 filed in the Korean Intellectual Property Office on Aug. 16, 2022, the entire contents of which are incorporated herein by reference.

### BACKGROUND

### 1. Technical Field

The present invention relates to a technology of providing a speech video.

### 2. Background Art

With the recent technological development in the field of artificial intelligence, various types of content are being generated based on artificial intelligence (AI) technology. For example, there is a case in which, when there is a voice message to be transmitted, a speech moving image (video) is generated as if a famous person (for example, a president) speaks the voice message in order to draw people's attention. This is achieved by generating mouth shapes or the like to fit a specific message, just like a famous person speaking the specific message in a moving image of the famous person.

In addition, technologies that allow artificial intelligence (AI) to conduct conversations with humans are being studied. In the technologies, synthesizing speech images takes time and requires a lot of data, and thus it is difficult to generate a video of a conversation (or speech video) in real time, which may lead to a problem.

### SUMMARY

An object is to provide an apparatus and a method for providing an artificial intelligence-based speech video in real time.

A method for providing a speech video performed by a computing device according to an exemplary embodiment includes reproducing a standby state video in a video file format in which a person in the video is in a standby state, generating a plurality of speech state images in which the person in the video is in a speech state and a speech voice based on a source of speech contents during the reproduction of the standby state video, stopping the reproduction of the standby state video and reproducing a back motion video in a video file format for returning to a reference frame of the standby state video, and generating a synthesized speech video by synthesizing the plurality of speech state images and the speech voice with the standby state video from the reference frame.

The back motion video may include a plurality of back motion frame sets for image interpolation between each frame of the standby state video and the reference frame.

The reproducing of the back motion video may include detecting, when the generating of the plurality of speech state images and the speech voice is completed, a closest frame having a back motion frame set among frames of the standby state video after completion, detecting a back motion frame set section corresponding to the detected frame in the back motion video, and reproducing the standby state video up to the detected frame and then reproducing the back motion frame set section.

The reference frame may be a first frame.

The generating of the standby state video may include repeatedly reproducing the standby state video.

The plurality of speech state images may be face images of the person in the video.

In the generating of the synthesized speech video, the synthesized speech video may be generated by replacing a face of the person in the video with each speech state image from the reference frame and synthesizing the speech state image and the speech voice.

A speech video providing apparatus according to another aspect includes a speech state image generator configured to generate a plurality of speech state images based on a source of speech contents during reproduction of a standby state video of a video file format in which a person in the video is in a standby state, a speech voice generator configured to generate a speech voice based on the source of the speech contents during the reproduction of the standby state video, a reproducer configured to reproduce the standby state video, and stop reproducing the standby state video when the generation of the plurality of speech state images and the speech voice is completed and reproduce a back motion video in a video file format for returning to a reference frame of the standby state video, and a synthesized speech video generator configured to generate a synthesized speech video by synthesizing the plurality of speech state images and the speech voice with the standby state video from the reference frame.

The back motion video may include a plurality of back motion frame sets for image interpolation between each frame of the standby state video and the reference frame.

The reproducer may be configured to detect, when the generating of the plurality of speech state images and the speech voice is completed, a closest frame having a back motion frame set among frames of the standby state video after completion, detect a back motion frame set section corresponding to the detected frame in the back motion video, and reproduce the standby state video up to the detected frame and then reproduce the back motion frame set section.

The reference frame may be a first frame.

The reproducer may repeatedly reproduce the standby state video.

The plurality of speech state images may be face images of the person in the video.

The synthesized speech video generator may generate the synthesized speech video by replacing a face of the person in the video with each speech state image from the reference frame and synthesizing the speech state image and the speech voice.

By using a standby state video and a back motion video in a video file format rather than an image file format, it is possible to reduce a loading time of a terminal compared to the image file format, and accordingly, it is possible to add various postures or gestures of a person to the standby state video.

In addition, by preparing the standby state video in advance, generating speech state images and a speech voice during reproduction of the standby state video, and synthesizing the generated image and voice with the standby state video, it is possible to generate the synthesized speech video in real time, and accordingly, it is possible to provide conversation-related services based on artificial intelligence in real time.

In addition, by generating the synthesized speech video by generating speech state images for a face part of a person in the standby state video and replacing only the face part of the standby state video with the speech state images, it is possible to reduce the amount of data while reducing the time required for generating the synthesized speech video.

In addition, by preparing a back motion image set for the frames of the standby state video, returning the standby state video being reproduced to a first frame through the back motion image set, and then synthesizing the speech state images and the speech voice from the first frame of the standby state video, it is possible to easily generate the synthesized speech video even without considering other factors, no matter when the speech state image and the speech voice are generated during the reproduction of the standby state video.

### BRIEF DESCRIPTION OF THE DRAWINGS

FIG. 1 is a diagram illustrating a conversation system using artificial intelligence according an exemplary embodiment.

FIG. 2 is a diagram illustrating a speech video providing apparatus according to an exemplary embodiment.

FIG. 3 is a diagram for describing a process of synthesizing a speech state image and a speech voice with a standby state video according to an exemplary embodiment.

FIG. 4 is a diagram for describing a back motion video according to an exemplary embodiment.

FIG. 5 is a diagram for describing a process of returning a standby state video being reproduced to a first frame according to an exemplary embodiment.

FIG. 6 is a diagram illustrating a method for providing a speech video according to an exemplary embodiment.

FIG. 7 is a block diagram exemplarily illustrating a computing environment that includes a computing device suitable for use in exemplary embodiments.

### DETAILED DESCRIPTION

Hereinafter, one embodiment of the present invention will be described in detail with reference to the accompanying drawings. In adding reference numerals to the components of each drawing, it should be noted that the same components are given the same reference numerals as much as possible even though they are shown on different drawings. In addition, in describing the present invention, if it is determined that the detailed description of the known function or configuration related to the present invention may unnecessarily obscure the subject matter of the present invention, the detailed description thereof will be omitted.

Meanwhile, for steps described herein, each step may occur differently from a stated order unless a specific order is clearly stated in the context. That is, each step may be performed in the same order as stated, may be performed substantially simultaneously, or may be performed in the opposite order.

The terms below described are defined in consideration of functions in the present invention, but may be changed depending on the customary practice, the intention of a user or operator, or the like. Thus, the definitions should be determined based on the overall content of the present specification.

It will be understood that, although the terms first, second, etc. may be used herein to describe various elements, the elements should not be limited by these terms. These terms are only used to distinguish one element from another element. Any references to singular may include plural unless expressly stated otherwise in the context, and it will be further understood that the terms “includes” and/or “having”, when used in this specification, specify the presence of stated features, numbers, steps, operations, elements, components, or combinations thereof, but do not preclude the presence or addition of one or more other features, numbers, steps, operations, elements, components, or combinations thereof.

In addition, components in the present specification are discriminated merely according to a function mainly performed by each component. That is, two or more components may be integrated into a single component, or a single component may be separated into two or more components for more detailed functions. Moreover, it is to be noted that each component may additionally perform some or all of a function executed by another component in addition to the main function thereof, and some or all of the main function of each component may be exclusively carried out by another component. Each component may be implemented as hardware or software, or implemented as a combination of hardware and software.

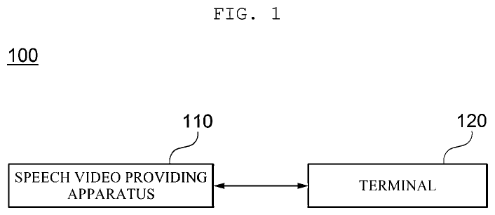

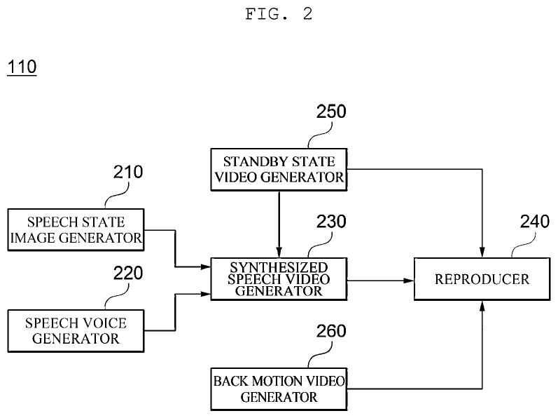

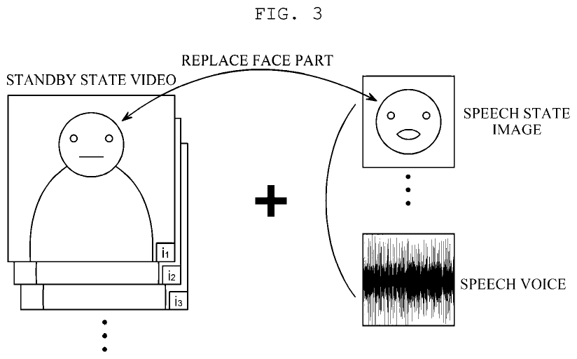

FIG. 1 is a diagram illustrating a conversation system using artificial intelligence according to an exemplary embodiment, FIG. 2 is a diagram illustrating a speech video providing apparatus according to an exemplary embodiment, and FIG. 3 is a diagram for describing a process of synthesizing a speech state image and a speech voice with a standby state video according to an exemplary embodiment.

Referring to FIGS. 1 to 3, a conversation system 100 using artificial intelligence may include a speech video providing apparatus 110 and a terminal 120.

The speech video providing apparatus 110 may communicate with the terminal 120 and perform a conversation with a user using the terminal 120 by using artificial intelligence (AI conversation).

The speech video providing apparatus 110 may generate a synthesized speech video in response to text or voice input through the terminal 120 and provide the generated synthesized speech video to the terminal 120.

According to an exemplary embodiment, the synthesized speech video may be a video synthesized based on artificial intelligence and may be a video in which a predetermined person speaks. Here, the predetermined person may be a virtual person or a person widely known to the public, but is not limited thereto.

As illustrated in FIG. 2, the speech video providing apparatus 110 may include a speech state image generator 210, a speech voice generator 220, a synthesized speech video generator 230, and a reproducer 240.

The speech state image generator 210 may generate a plurality of speech state images based on a source of speech contents during reproduction of the standby state video. In this case, the speech state image may be an image in which a person in the video (a person with the same identity as the person in the standby state video) is in a speech state (a state of speaking to a conversation partner).

According to an exemplary embodiment, the speech state image may be a face image of the person in the standby state video. In this way, the speech state image generator 210 generates speech state images including only the face of the person in the standby state video, thereby generating the speech state images more quickly and reducing data capacity.

The standby state video is a video in which the person in the video is in a standby state, and may be formed in a video file format (e.g., WebM, Matroska, Flash Video (FLV), F4V, VOB, Ogg Video, Dirac, AVI, AMV, SVI, 3GPP, Windows Media Video, Advanced System Format (ASF), MPEG, or the like). Here, the standby state may be a state before the person in the video speaks (e.g., a state in which the person is listening to the other person or a state in which there is no speech before a conversation, or the like).

The standby state video has a predetermined reproduction time, and may be provided to express natural movements while the person in the video is in the standby state. That is, the standby state video may be provided to naturally express the facial expression, posture, and action (e.g., nodding, holding hands and listening, tilting the head, and smiling) of the person in the video while the person is listening to a conversation partner.

The source of the speech contents is a response to text or voice input through the terminal 120 and may be in a text form, but is not limited thereto and may also be in a voice form.

The source of the speech contents may be generated through artificial intelligence by the speech video providing apparatus 110 analyzing text or voice input through the terminal 120, but is not limited to thereto, the source of the speech contents may be input from an external device (for example, a device that generates the source of the speech contents by analyzing text or voice input through the terminal 120) or an administrator.

The speech voice generator 220 may generate a speech voice based on the source of the speech contents during the reproduction of the standby state video. Here, the speech voice may correspond to a plurality of speech state images generated by the speech state image generator 210. That is, based on the same source of speech contents, the speech state image generator 210 may generate the plurality of speech state images, and the speech voice generator 220 may generate the speech voice.

Meanwhile, the technology for generating an image or voice based on a source (text or voice) of speech contents is a known technology, so a detailed description thereof will be omitted.

The synthesized speech video generator 230 may generate a synthesized speech video by synthesizing the plurality of speech state images generated by the speech state image generator 210 and the speech voice generated by the speech voice generator 220 with the standby state video.

For example, as illustrated in FIG. 3, the synthesized speech video generator 230 may generate the synthesized speech video by replacing a face of the person in the standby state video with the speech state image (that is, a face part of the person) and synthesizing the speech state image and the speech voice.

According to an exemplary embodiment, the synthesized speech video generator 230 may synthesize each speech state image and speech voice from a reference frame of the standby state video. Here, the reference frame may be the first frame of the standby state video, but is not limited thereto. That is, synthesis of the standby state video, the speech state image, and the speech voice may be performed starting from the reference frame (e.g., the first frame) of the standby state video.

The speech video providing apparatus 110 according to an exemplary embodiment may unify a synthesis point of the standby state video, the speech state image, and the speech voice into the reference frame (e.g., the first frame) of the standby state video, thereby easily generating the synthesized speech video by synthesizing the standby state video, the speech state image, and the speech voice even without considering other factors (for example, the network environment between the speech video providing apparatus 110 and the terminal 120 or the like), no matter when the speech state image and the speech voice are generated during the reproduction of the standby state video. Hereinafter, a case where the reference frame is the first frame will be described as an example.

The reproducer 240 may reproduce the standby state video and transmit the standby state video to the terminal 120.

According to an exemplary embodiment, the reproducer 240 may repeatedly reproduce the standby state video. For example, the reproducer 240 may repeatedly reproduce the standby state video in a method for reproducing the standby state video from the first frame to the last frame and then returning the standby state video to the first frame. In this case, when reproduction of the last frame of the standby state video is completed, as will be described below, the reproducer 240 may naturally return the standby state video to the first frame by stopping reproducing the standby state video and reproducing a back motion frame set of a back motion video corresponding to the last frame of the standby state video.

When the generation of the speech state image and the speech voice is completed during the reproduction of the standby state video, the reproducer 240 may stop reproducing the standby state video, reproduce the back motion video, and transmit the back motion video to the terminal 120.

The back motion video is for image interpolation between an arbitrary frame of the standby state video and the reference frame of the standby state video, and may be formed in a video file format (e.g., WebM, Matroska, Flash Video (FLV), F4V, VOB, Ogg Video, Dirac, AVI, AMV, SVI, 3GPP, Windows Media Video, Advanced System Format (ASF), MPEG, or the like). Through the back motion video, when returning from the arbitrary frame of the standby state video to the reference frame of the standby state video, the arbitrary frame and the reference frame may be naturally connected. Here, natural connection between frames may mean that the movements of a person in the video are naturally connected.

The back motion video may include a plurality of back motion frame sets (may be referred to as back motion image sets). That is, a plurality of back motion frame sets may be gathered to form one back motion video. Each back motion frame set may be provided for image interpolation between each frame of the standby state video and the reference frame. For example, the back motion frame set may be prepared for each frame of the standby state video at each preset frame interval or preset time interval. For example, when the preset frame interval is three, a back motion frame set may be prepared for the third frame, sixth frame, ninth frame, etc. of the standby state video.

According to the exemplary embodiment, when the generation of the speech state image and the speech voice is completed during the reproduction of the standby state video, the reproducer 240 may detect the closest frame having a back motion frame set among subsequent frames of the standby state video and detect a section in which a back motion frame set corresponding to the detected frame of the standby state video exists in the back motion video (hereinafter referred to as a back motion frame set section). In addition, the reproducer 240 may naturally return the standby state video to the first frame by reproducing the standby state video up to the detected frame and then reproducing the detected back motion frame set section of the back motion video.

The reproducer 240 may reproduce the detected back motion frame set section of the back motion video, and then reproduce the synthesized speech video and transmit the synthesized speech video to the terminal 120.

As described above, the synthesized speech video may be generated by synthesizing the speech state image and the speech voice from the first frame of the standby state video. Therefore, the last reproduced frame of the standby state video and the synthesized speech video may be naturally connected through reproduction of the corresponding back motion frame set section of the back motion video.

When the reproduction of the synthesized speech video ends, the reproducer 240 may reproduce the standby state video again from an ending point in time of the synthesized speech video. In addition, when the reproducer 240 reproduces the standby state video up to the last frame, the reproducer 240 may returns the standby state video to the first frame again using the back motion frame set of the back motion video corresponding to the last frame of the standby state video and reproduce the standby state video.

According to an exemplary embodiment, the speech video providing apparatus 110 may further include a standby state video generator 250 and a back motion video generator 260.

The standby state video generator 250 may generate a standby state video with a predetermined reproduction time. For example, the standby state video generator 250 may generate one standby state video in a video file format by encoding a plurality of standby state images. As described above, a standby state video may express natural actions taken by the person in the video while in the standby state.

At each frame interval or time interval preset for frames of the standby state video, the back motion video generator 260 may generate a back motion image set corresponding to the interval. In addition, the back motion video generator 260 may generate one back motion video in a video file format by encoding the generated back motion image sets.

The terminal 120 may be communicably connected to the speech video providing apparatus 110 through a communication network.

According to an exemplary embodiment, the communication network may include the Internet, one or more local area networks, wide area networks, cellular networks, mobile networks, other types of networks, or a combination of the above networks.

The terminal 120 may include, for example, a user terminal that wishes to communicate with artificial intelligence (e.g., a smartphone, tablet PC, laptop, desktop PC, or the like), an unmanned ordering kiosk, an electronic information desk, an outdoor advertising screen, robots, or the like.

The terminal 120 may access the speech video providing apparatus 110 through a communication network. In this case, the terminal 120 needs a loading process to receive the standby state video and the back motion video from the speech video providing apparatus 110. However, when the standby state video and the back motion video are in an image file format rather than a video file format, the data size is large, so it takes a long time to load, and accordingly, there is a limit to adding a posture or gesture of a person in the standby state.

The speech video providing apparatus 110 according to an exemplary embodiment may use the standby state video and the back motion video in a video file format rather than an image file format, thereby making it possible to reduce the loading time of the terminal 120 compared to the image file format, and accordingly, possible to add various postures or gestures of the person in the standby state.

The speech video providing apparatus 110 according to an exemplary embodiment may prepare the standby state video in advance, generate speech state images and a speech voice during reproduction of the standby state video, and synthesize the generated image and voice with the standby state video, thereby making it possible to generate the synthesized speech video in real time, and accordingly, possible to provide conversation-related services based on artificial intelligence in real time.

In addition, by generating the synthesized speech video by generating speech state images for a face part of a person in the standby state video and replacing only the face part of the standby state video with the speech state images, it is possible to reduce the amount of data while reducing the time required for generating the synthesized speech video.

In addition, by preparing a back motion image set for the frames of the standby state video, returning the standby state video being reproduced to a first frame through the back motion image set, and then synthesizing the speech state images and the speech voice from the first frame of the standby state video, it is possible to easily generate the synthesized speech video even without considering other factors, no matter when the speech state image and the speech voice are generated during the reproduction of the standby state video.

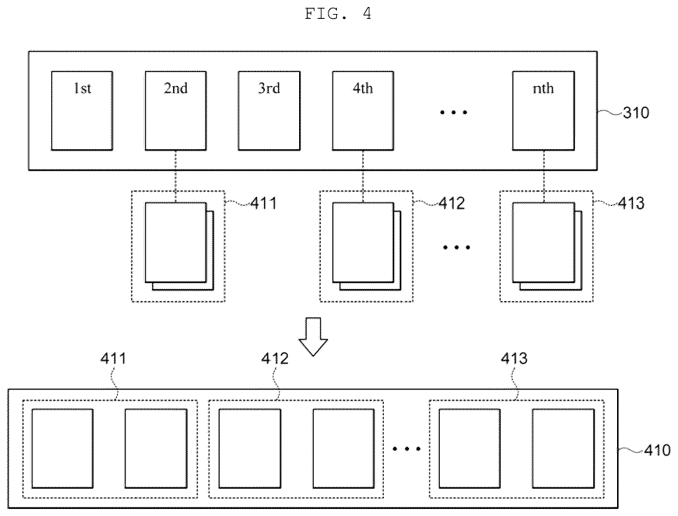

FIG. 4 is a diagram for describing a back motion video according to an exemplary embodiment. FIG. 4 illustrates a case where a preset frame interval is two.

Referring to FIG. 4, the back motion video generator 260 may generate back motion image sets 411, 412, and 413 at each two-frame interval, that is, at a second frame 2nd, a fourth frame 4th, . . . , and an nth frame nth of the standby state video 310. In this case, the back motion image set 411 may be provided to naturally connect the second frame 2nd to a first frame 1st, the back motion image set 412 may be provided to naturally connect the fourth frame 4th to the first frame 1st, and the back motion image set 413 may be provided to naturally connect the nth frame nth to the first frame 1st.

The back motion video generator 260 may generate one back motion video 410 in a video file format by sequentially listing and encoding the back motion image sets 411, 412, and 413.

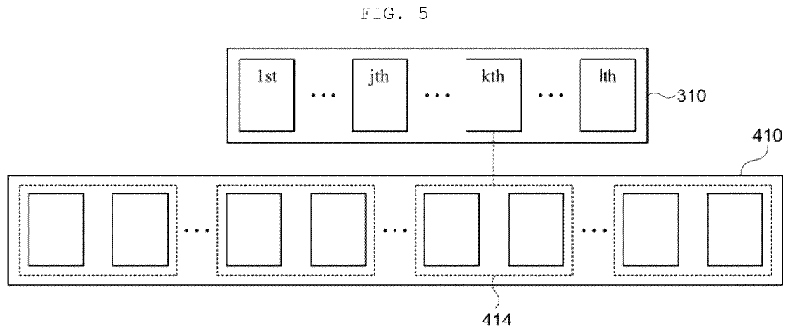

FIG. 5 is a diagram for describing a process of returning a standby state video being reproduced to a first frame according to an exemplary embodiment.

Referring to FIG. 5, when generation of a speech state image and a speech voice is completed in a jth frame jth during reproduction of the standby state video 310, the reproducer 240 may detect the closest frame having a back motion image set among the frames kth and lth after the jth frame jth.

For example, when the closest frame having a back motion image set among the subsequent frames kth and lth is the kth frame kth, the reproducer 240 may detect a back motion image set 414 corresponding to the kth frame kth in the back motion video 410 and return the standby state video 310 to the first frame 1st using the detected back motion image set 414. That is, the reproducer 414 may naturally return the standby state video 310 to the first frame by reproducing the standby state video 310 up to the kth frame kth and then reproducing the back motion image set 414 of the back motion video 410. In addition, the synthesized speech video generator 230 may generate a synthesized speech video by synthesizing the speech state image and the speech voice in the first frame 1st of the standby state video 310, and the reproducer 414 may reproduce the back motion image set 414 and then reproduce the synthesized speech video. In this way, the kth frame kth and the synthesized speech video may be naturally connected.

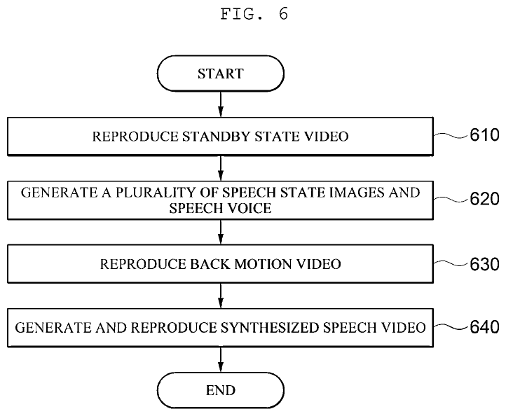

FIG. 6 is a diagram illustrating a method for providing a speech video according to an exemplary embodiment. The method for providing a speech video in FIG. 6 may be performed by the speech video providing apparatus in FIG. 1.

Referring to FIG. 6, the speech video providing apparatus may reproduce a standby state video (610). In this case, the standby state video is a video in which a person in the video is in a standby state and may be formed in a video file format.

The speech video providing apparatus may generate a plurality of speech state images and a speech voice based on a source of speech contents (620).

The source of speech contents may be in a text or voice form as a response to text or voice input through a terminal connected to the speech video providing apparatus through a communication network. The source of speech contents may be generated through artificial intelligence by analyzing the text or voice input through the terminal.

The speech state image is an image in which a person in a standby state video is speaking, and may be an image of a face of the person in the video.

The speech video providing apparatus may stop reproducing the standby state video and reproduce a back Here, the back motion video is for motion video (630). image interpolation between an arbitrary frame of the standby state video and a reference frame of the standby state video and may be formed in a video file format. The back motion video may include a plurality of back motion frame sets provided for image interpolation between each frame of the standby state video and the reference frame.

For example, when the generation of the speech state images and the speech voice is completed during the reproduction of the standby state video, the speech video providing apparatus may detect the closest frame having a back motion frame set among subsequent frames of the standby state video and detect a back motion frame set section corresponding to the detected frame of the standby state video in the back motion video. In addition, the speech video providing apparatus may naturally return the standby state video to the first frame by reproducing the standby state video up to the detected frame and then reproducing the detected back motion frame set section of the back motion video.

The speech video providing apparatus may generate and reproduce a synthesized speech video by synthesizing a plurality of speech state images and a speech voice with the standby state video (640).

For example, the speech video providing apparatus may generate the synthesized speech video by replacing the face of the person in the standby state video with the speech state images (that is, a face part of the person) from the first frame of the standby state video and synthesizing the speech state image and the speech voice.

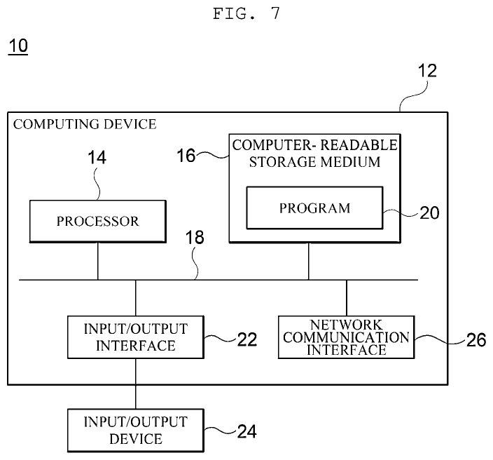

FIG. 7 is a block diagram exemplarily illustrating a computing environment that includes a computing device suitable for use in exemplary embodiments. In the illustrated embodiment, each component may have a different function and capability in addition to those described below, and additional components may be included in addition to those described below.

The illustrated computing environment 10 includes a computing device 12. In one embodiment, the computing device 12 may be the speech video providing apparatus 110.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In one embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as one of components constituting the computing device 12, or may be connected to the computing device 12 as a separate device distinct from the computing device 12.

As described above, the present invention has been shown and described with reference to preferred embodiments thereof. It will be understood by those skilled in the art that the present invention may be implemented in a modified form within the scope without departing from the essential characteristics of the present invention. Accordingly, the scope of the present invention is not limited to the above-described embodiments, but should be construed to include various embodiments within the scope equivalent to the content described in the claims.

1. A method for providing a speech video performed by a computing device, the method comprising:
reproducing a standby state video in a video file format in which a person in the video is in a standby state;
generating a plurality of speech state images in which the person in the video is in a speech state and a speech voice based on a source of speech contents during the reproduction of the standby state video;
stopping the reproduction of the standby state video and reproducing a back motion video in a video file format for returning to a reference frame of the standby state video; and
generating a synthesized speech video by synthesizing the plurality of speech state images and the speech voice with the standby state video from the reference frame.

2. The method of claim 1, wherein the back motion video includes a plurality of back motion frame sets for image interpolation between each frame of the standby state video and the reference frame.

3. The method of claim 2, wherein the reproducing of the back motion video includes:
detecting, when the generating of the plurality of speech state images and the speech voice is completed, a closest frame having a back motion frame set among frames of the standby state video after completion;
detecting a back motion frame set section corresponding to the detected frame in the back motion video; and
reproducing the standby state video up to the detected frame and then reproducing the back motion frame set section.

4. The method of claim 1, wherein the reference frame is a first frame.

5. The method of claim 1, wherein the generating of the standby state video includes repeatedly reproducing the standby state video.

6. The method of claim 1, wherein the plurality of speech state images are face images of the person in the video.

7. The method of claim 6, wherein in the generating of the synthesized speech video, the synthesized speech video is generated by replacing a face of the person in the video with each speech state image from the reference frame and synthesizing the speech state image and the speech voice.

8. An apparatus for providing a speech video, the apparatus comprising:
a speech state image generator configured to generate a plurality of speech state images based on a source of speech contents during reproduction of a standby state video of a video file format in which a person in the video is in a standby state;
a speech voice generator configured to generate a speech voice based on the source of the speech contents during the reproduction of the standby state video;
a reproducer configured to reproduce the standby state video, and stop reproducing the standby state video when the generation of the plurality of speech state images and the speech voice is completed and reproduce a back motion video in a video file format for returning to a reference frame of the standby state video; and
a synthesized speech video generator configured to generate a synthesized speech video by synthesizing the plurality of speech state images and the speech voice with the standby state video from the reference frame.

9. The apparatus of claim 8, wherein the back motion video includes a plurality of back motion frame sets for image interpolation between each frame of the standby state video and the reference frame.

10. The apparatus of claim 9, wherein the reproducer is configured to:
detect, when the generating of the plurality of speech state images and the speech voice is completed, a closest frame having a back motion frame set among frames of the standby state video after completion;
detect a back motion frame set section corresponding to the detected frame in the back motion video; and
reproduce the standby state video up to the detected frame and then reproduce the back motion frame set section.

11. The apparatus of claim 8, wherein the reference frame is a first frame.

12. The apparatus of claim 8, wherein the reproducer repeatedly reproduces the standby state video.

13. The apparatus of claim 8, wherein the plurality of speech state images are face images of the person in the video.

14. The apparatus of claim 13, wherein the synthesized speech video generator generates the synthesized speech video by replacing a face of the person in the video with each speech state image from the reference frame and synthesizing the speech state image and the speech voice.
